(19) United States
(12) Patent Application Publication
(10) Pub. No.: US 2016/0036181 A1
(43) Pub. Date: Feb. 4, 2016

(54) CONNECTOR DEVICE FOR ELECTRONIC COMMUNICATION SYSTEM

(71) Applicant: ELECTRO-MOTIVE DIESEL, Inc., La Grange, IL (US)

(72) Inventor: Joseph Siergiej, Homer Glen, IL (US)

(73) Assignee: ELECTRO-MOTIVE DIESEL, Inc., La Grange, IL (US)

(21) Appl. No.: 14/879,098

(22) Filed: Oct. 9, 2015

(51) Int. Cl. H01R 25/00

(52) U.S. Cl. CPC H01R 25/00

(57) ABSTRACT

A connector device for an electronic communication system of a locomotive is provided. The electronic communication system includes a communication device, a power source, and a controller. The connector device includes a body, a first connection port, a second connection port, and a third connection port. The body includes a first end and a second end. The first connection port attaches the connector device to the controller. The second connection port connects the power source to the connector device, by a first cable. The third connection port connects the communication device by a second cable to the connector device. The first connection port and the third connection port are in electrical communication with the second connection port. The connector device is configured to split power received from the power source between each of the communication device and the controller.

### TECHNICAL FIELD

The present disclosure relates to a multiple terminal connector devices. More particularly, the present disclosure relates to a connector device for electronic communication system in locomotives.

### BACKGROUND

Machines such as a locomotive consist are known to use on-board cab communication systems. The cab communication system is equipped with one or more communication product packages. As such, conventional communication product package includes a controller and one or more communication devices. Some of the problems currently encountered with conventional communication product package are the complexity of disparate components within the cab communication system that need to communicate with each other. Additionally, some communication product packages may suffer from a lack of robust, mission critical, extensible and scalable components, which results in an undesirably higher cost, and a less standardized and flexible architecture. Many times during development of a new locomotive, the approach to provide input power to the communication device may significantly increase the cost of the communication product package. This additional cost might even inhibit potential customers from considering the communication product package.

PCT Application Number WO2010071304A2 discloses a power divider with a coupling. The disclosed power divider includes a housing, an input connector, a first output connector, and a second output connector. The housing accommodates a first transmission line electrically coupled to the input connector and to the second output connector, and a second transmission line electrically coupled to the second output connector. However, the PCT application focusses on an inline split of a power supply into multiple outputs and require lot of sub-components. More number of sub-components used not only increase the manufacturing time and cost of the assembly but also increases possibilities of failure.

The present disclosure is directed towards one or more above-mentioned problems.

### SUMMARY OF THE INVENTION

Various aspects of the present disclosure describe a connector device for an electronic communication system of a locomotive. The electronic communication system includes a communication device, a power source, and a controller. The connector device includes a body, a first connection port, a second connection port, and a third connection port. The body includes a first end and a second end. A wall is defined between the first end and the second end. The first connection port is positioned at the first end. The first connection port facilitates attachment of the connector device to the controller. The second connection port is positioned on the wall. The second connection port facilitates connection with the power source, by a first cable. This connects the connector device to the power source. The third connection port is positioned on the wall. The third connection port allows connection with the communication device by a second cable. The first connection port and the third connection port are in electrical communication with the second connection port. The connector device is configured to split power received from the power source between each of the communication device and the controller.

### BRIEF DESCRIPTION OF THE DRAWINGS

FIG. 1 illustrates a pictorial view of an exemplary locomotive consist of two locomotives, in accordance with the concepts of the present disclosure;

FIG. 2 illustrates a layout of an electronic communication system in the locomotive of FIG. 1, in accordance with the concepts of the present disclosure;

FIG. 3 illustrates a partial view of a controller with a connector device of the electronic communication system of FIG. 2, in accordance with the concepts of the present disclosure;

FIG. 4 is a perspective view of the connector device of FIG. 3, in accordance with the concepts of the present disclosure; and

FIG. 5 is a cross-sectional view of the connector device of FIG. 4 along a cutting plane X-X, in accordance with the concepts of the present disclosure.

### DETAILED DESCRIPTION

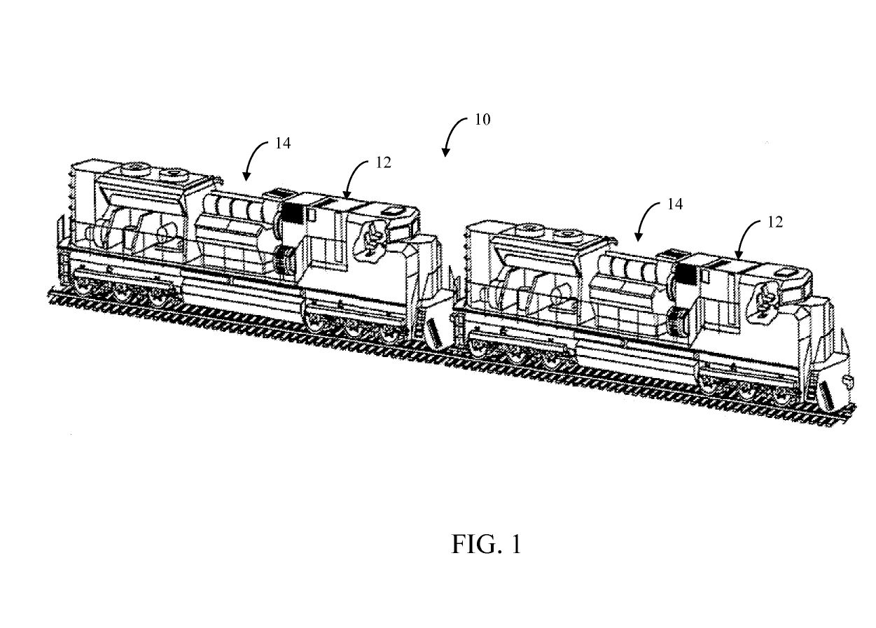

Referring to FIG. 1, there is shown a locomotive consist 10. The term “locomotive consist 10” means one or more locomotives 12 physically connected together, with one locomotive 12 designated as a lead locomotive and the others as trailing locomotives. Each locomotive 12 may include a power source 14. In one embodiment, the power source 14 may comprise a uniflow two-stroke diesel engine system. Those skilled in the art will also appreciate that each locomotive 12 may also include an operator cab (not shown), facilities used to house electronics, such as electronics lockers (not shown), protective housings for the power source 14, and a generator used in conjunction with the power source 14.

While not shown in FIG. 1, the locomotive consist 10 may include more than two locomotives 12. Additionally, the locomotive consist 10 may also comprise a variety of other railroad cars, such as freight cars or passenger cars, and may employ different arrangements of the cars and locomotives to suit the particular use of the locomotive consist 10. In an embodiment, the locomotives 12 within the locomotive consist 10 communicate with each other through wired communication or wireless communication.

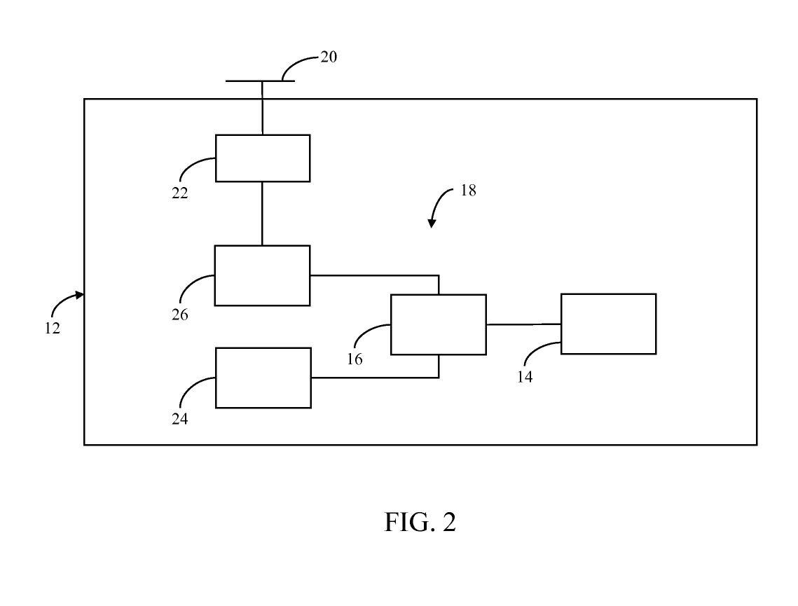

FIG. 2 illustrates layout of a connector device 16 with elements of an electronic communication system 18 disposed within the locomotive 12. The electronic communication system 18 includes the power source 14, a network 20, a network interface 22, a communication device 24, and a controller 26. The network interface 22, the communication device 24, and the controller 26 may draw power from the power source 14.

The network 20 is disposed within the locomotives 12 as part of the electronic communication system 18 for the locomotives 12. The network 20 may include one or more different data communication paths over which data having different communication formats may be transmitted. For example, the network 20 may be used to transmit Ethernet TCP/IP based data, RS 232 data, RS422 data, controller area network (CAN) bus data, or a combination of two or more of these data.

The network interface 22 may be configured to couple the electronic communication system 18 to the network 20. The network interface 22 is coupled to the controller 26. In one example, the network interface 22 may be an Ethernet switch. However, other types of network or communication interfaces may suffice to operatively couple the electronic communication system 18 to the network 20.

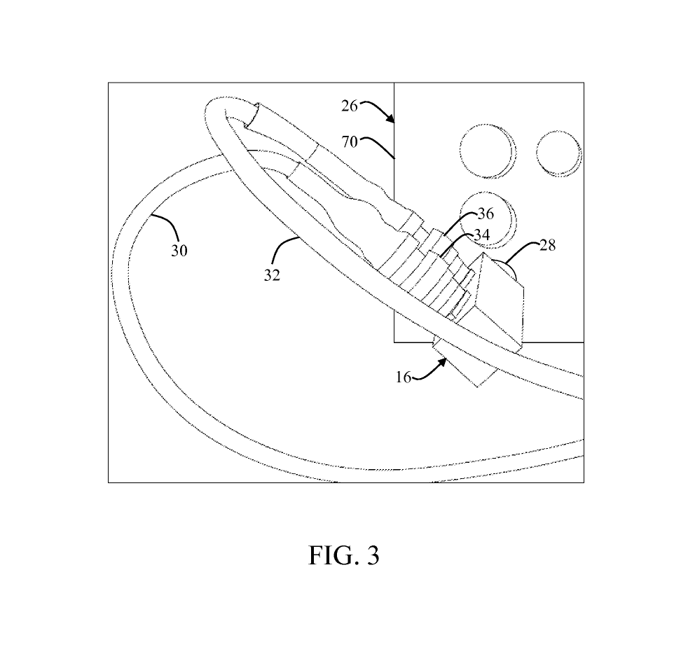

Referring to FIGS. 2 and 3, the controller 26 contains internal circuitry that is configurable to implement control of the locomotives 12. In other words, the internal circuitry of the controller 26 may be altered in different configurations to implement one or more control functions associated with the locomotives 12. The controller 26 includes a number of ports, including a connector port 28 for attachment of the connector device 16. The controller 26 is powered by electrical communication with the power source 14. The electrical communication between the power source 14 and the controller 26 is provided by the connector device 16. In addition, the controller 26 is in control communication with the communication device 24 and the network 20. An electrical connection between the controller 26 and the communication device 24 is provided by the connector device 16. The connector device 16 also provides an identification address to the controller 26 to make the controller 26 a unique entity in the network 20.

The communication device 24 is generally a device that provides communication within or outside the locomotives 12. In other words, the communication device 24 receives and/or transmits navigational information within or outside the locomotives 12. An example of the communication device 24 may include, but is not limited to, an analog radio, a digital communication receiver/transmitter, a GPS unit, and a tracking transponder. The communication device 24 is connected to the connector device 16 via the connector device 16.

The connector device 16 is coupled to the controller 26 and provides power to the controller 26. Further the connector device 16 also facilitates electrical connection of the power source 14 with the communication device 24 and the controller 26. A first cable 30 is provided for connection between the connector device 16 and the power source 14. A second cable 32 is provided for connection between the communication device 24 and the connector device 16. The first cable 30 and the second cable 32 include a first terminal 34 and a second terminal 36, respectively. The first terminal 34 and the second terminal 36 are attached to the connector device 16, thereby coupling, respectively, the first cable 30 and the second cable 32 to the connector device 16. The first cable 30 allows connection of the power source 14 with the connector device 16. Thus, input power is supplied to the controller 26 via the connector device 16. The second cable 32 allows connection of the communication device 24 to the controller 26 via the connector device 16.

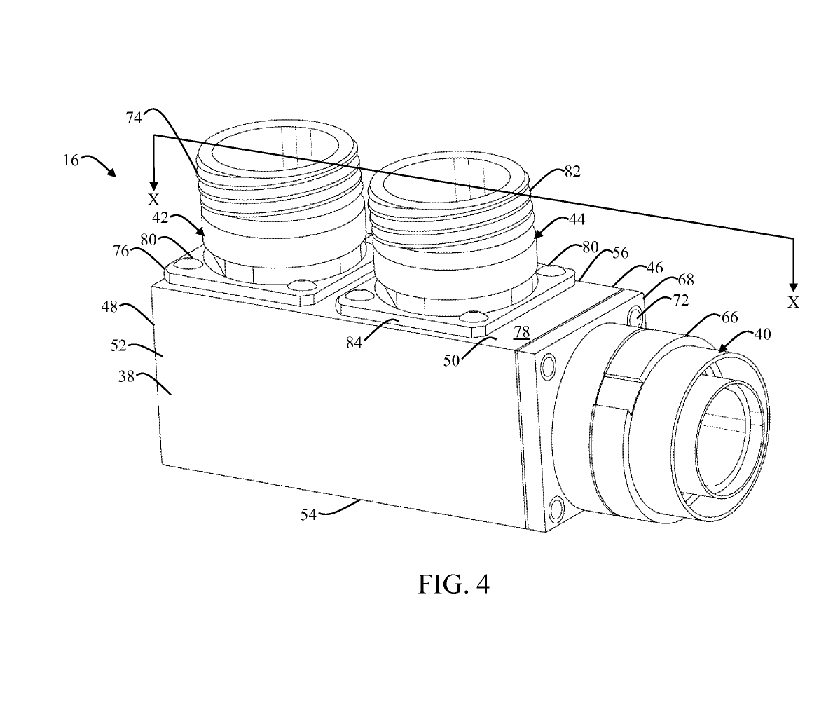

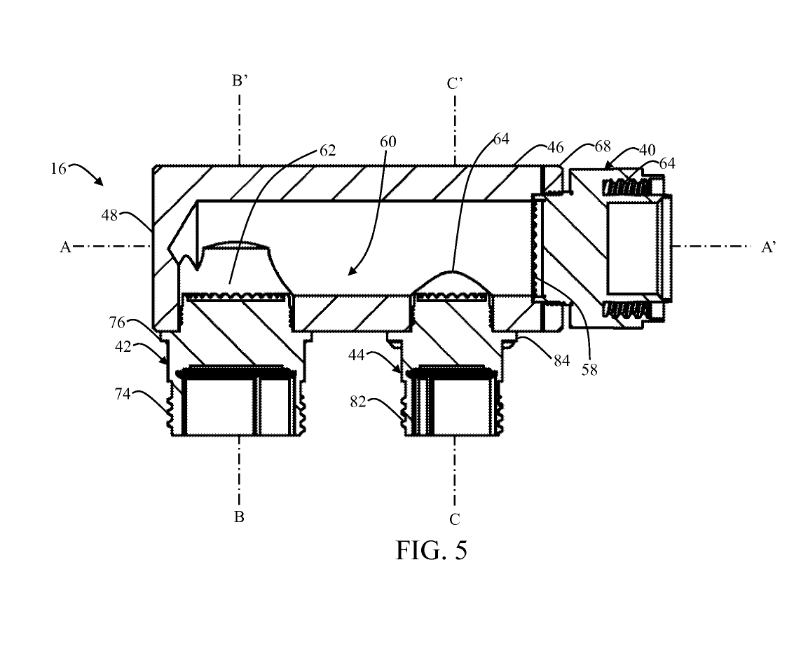

Referring to FIGS. 4 and 5, there is shown the connector device 16. The connector device 16 receives power from the power source 14. The connector device 16 splits power received between each of the communication device 24 and the controller 26. The connector device 16 includes a body 38, a first connection port 40, a second connection port 42, and a third connection port 44. The body 38 includes a first end 46, a second end 48, a first wall 50, a second wall 52, a third wall 54, and a fourth wall 56. Further, the first end 46 includes a first hole 58.

The walls 50, 52, 54, and 56 are defined between the first end 46 and the second end 48. The walls 50, 52, 54, and 56 enclose and define an interior space 60 which houses wires for electrical communication. The first wall 50 is attached to the second wall 52 and the fourth wall 56. The first wall 50 includes a second hole 62 and a third hole 64. The second hole 62 is proximal to the second end 48. The third hole 64 is proximal to the first end 46. The second hole 62 and the third hole 64 are openings to the interior space 60 of the connector device 16. The second wall 52 is attached to the first wall 50 and the third wall 54. The third wall 54 is attached to the fourth wall 56.

The first connection port 40 is positioned at the first end 46. The first connection port 40 facilitates attachment of the connector device 16 to the controller 26. The first connection port 40 includes a first neck portion 66 and a first mounting plate 68. The first neck portion 66 is a threaded portion for attachment to a board 70 of the controller 26 (FIG. 3). The first neck portion 66 is aligned along a longitudinal axis A-A′. The first neck portion 66 is attached onto the first mounting plate 68. The first mounting plate 68 is secured at the first end 46, via fasteners 72. The attachment is such that the first neck portion 66 aligns with the first hole 58. This allows wires (not shown) extending from the first neck portion 66 to pass through the first hole 58 and house inside the body 38 of the connector device 16.

The second connection port 42 is positioned on the first wall 50. The second connection port 42 is aligned along a first transversal axis B-B′. The second connection port 42 includes a second neck portion 74 and a second mounting plate 76. The second neck portion 74 is a screwed portion for attachment of the first cable 30 to the connector device 16. The second neck portion 74 is attached onto the second mounting plate 76. The second mounting plate 76 is secured on an external surface 78 of the first wall 50, via fasteners 80. The second connection port 42 is attached to the first wall 50 such that the second neck portion 74 coincides with the second hole 62. This allows wires (not shown) of the second connection port 42 to enter the interior space 60 of the connector device 16.

The third connection port 44 is disposed on the first wall 50. The third connection port 44 is aligned along a second transversal axis C-C′. The third connection port 44 includes a third neck portion 82 and a third mounting plate 84. The third neck portion 82 is a screwed portion for attachment of the second cable 32 to the connector device 16. The third neck portion 82 is attached onto the third mounting plate 84. The third mounting plate 84 is secured on the external surface 78 of the first wall 50, via the fasteners 80. The third connection port 44 is attached to the first wall 50 such that the third neck portion 82 coincides with the third hole 64. Hence, wires (not shown) of the second connection port 42 enter the interior space 60 of the connector device 16.

### INDUSTRIAL APPLICABILITY

In operation, the connector device 16 is plugged into the controller 26, via attachment of the first connection port 40 to the connector port 28. The connector device 16 is connected to the power source 14 through the first cable 30. The first cable 30 supplies electric power from the power source 14 to the second connection port 42 of the connector device 16. Hence, the connector device 16 receives power from the power source 14. This power is then divided by the connector device 16 and supplied to the communication device 24 and the controller 26. The divided power is supplied to the communication device 24 via the third connection port 44, where the second cable 32 is connected. The second cable 32 then transfers the divided power from the connector device 16 to the communication device 24. Similarly, the divided power is supplied to the controller 26 via the first connection port 40, where the attachment to the controller 26 is done.

The disclosed connector device 16 splits power between the controller 26 and the communication device 24. Another unique aspect of the connector device 16 is rotation orientation with respect to the controller 26. To avoid interference of other cables entering the controller 26, the connector device 16 may be keyed at a specific default angle. The connector device 16 is capable to rotate 180 degrees counter-clockwise from the default position (FIG. 2), to give more flexibility for installation of locomotives 12. Further, this feature also allows the connector device 16 to rotate, so that the connector device 16 does not rotate under normal locomotive vibrations. The disclosed connector device 16 draws input power without increasing the base cost of the controller 26. The connector device 16 is connected between original power plug of the power source 14 and the original communication device 24. The cost of the connector device 16 is built in with other configurations requiring the communication device 24, thus leaving the cost of the controller 26 intact. This eliminates need of a separate power supply for the communication radio. This also eliminates requirement to modify the controller 26 to support an additional power output for the communication device 24. The disclosed connector device 16 increases the reliability of a shared power source, as the connector device 16 is more robust and rugged. In an embodiment, the connector device 16 may apply to other areas within the locomotives 12 and not only power applicable but for communication type connections, where split routes are necessary.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to those skilled in the art. It is not desired to limit the disclosure to the exact construction and operation illustrated and described, and, accordingly, all suitable modifications and equivalents may be resorted to that fall within the scope of the disclosure.

What is claimed is:

1. A connector device for an electronic communication system of a locomotive, the electronic communication system having a communication device, a power source, and a controller, the connector device comprising:
a body having a first end and a second end, and at least one wall defined between the first end and the second end;
a first connection port positioned at the first end, the first connection port facilitates attachment of the connector device to the controller;
a second connection port positioned on the at least one wall, the second connection port facilitates connection of the power source to the connector device, by a first cable; and
a third connection port positioned on the at least one wall, the third connection port allows connection of the communication device by a second cable to the connector device, wherein the first connection port and the third connection port are in electrical communication with the second connection port;
wherein the connector device is configured to split power received from the power source between each of the communication device and the controller.
